(19) United States
(12) Patent Application Publication
(10) Pub. No.: US 2011/0240810 A1
(43) Pub. Date: Oct. 6, 2011

(54) Cup Holder

(76) Inventors: James Dominic France, Auckland (NZ); Mitchell Robert Edward Hughes, Whangaparaoa (NZ); Mihai Ivasiuc, Keller, TX (US)

(21) Appl. No.: 12/963,006

(22) Filed: Dec. 8, 2010

(30) Foreign Application Priority Data
Dec. 8, 2009 (AU) 2009905975

(51) Int. Cl. F16M 13/02; F16M 13/00

(52) U.S. Cl. 248/220.21; 248/292.14; 248/298.1; 248/205.1

(57) ABSTRACT

A cup holder comprising, a housing, a carrier member slidably engaged to the housing and movable between a condition where it is housed within the housing and condition where it at least partially extends from the housing, a cup receptacle that is slidably connected to the carrier member and carried thereby in a gimballed manner, wherein in an extended position the cup receptacle is presentable to be able to receive a cup, and wherein in a retracted position the cup receptacle is within the housing in a stowed condition.

### FIELD OF THE INVENTION

The present invention relates to a cup holder. More specifically, but not exclusively it relates to a cup holder for a seat of an aircraft.

### BACKGROUND OF THE INVENTION

Many beverage containers such as a can, bottle or cup (herein after referred to as a “cup”) once open or filled with a beverage cannot be tipped over without spilling the contents. It is therefore convenient to have a place to locate a cup in a secure location such that the contents are not spilt when a consumer does not want to hold the cup. Passengers using cups on an aircraft require a place to locate their cups in a secure position. In the confined space of a passenger's seat there is limited space to locate a cup in a secure position.

Traditionally cups and the like have been located on the surface of a tray table, deployable or otherwise. Whilst a tray table does provide a surface on which to place a cup they are still prone to the cups slipping, sliding or tipping on the surface of the tray table. Placing a cup on a tray table also relies on some tray tables being deployed which may not be convenient for all situations such as when a passenger wants to get up from their seat. Some tray tables have been adapted to include indents to help prevent the cups from sliding on the surface of the tray table. However, they can still be knocked over when bumped or in the event of turbulence.

An alternative method for securing a cup includes the use of a specialised cup holder for receiving and retaining a cup or equivalent beverage container within. There are known cup holders that are configured to hold a cup or container in a fixed relationship to a seat or a fixed surface. These fixed cup holders do not accommodate for the movement of a vehicle and can often take up a significant amount of space. Space on an aircraft and especially in a passenger seating area is very limited.

There are known deployable cup holders, although these are often bulky and cannot be easily incorporated in the limited space on the back of a seat. The back of a seat in an aircraft is often crowded with other utilities such as tray tables, IFE screens and detachable controllers, all of which compete for space with the internal structure of the seat itself.

Due to the structural requirements of an aircraft seat and the extensive safety tests they must undergo it is normally commercially more efficient and cheaper, when designing a new configuration of components on a seat back, to configure the components around the existing seat structure rather than changing the seat structure around the components.

All components on aircraft are designed to minimise their weight and manufacturing costs. As such cup holders are made from minimal amounts of material which inherently reduces their strength and durability. As a result it is not uncommon for cup holders to be damaged or broken, in which case they must be replaced.

It is an object of the present invention to provide improvements in or relating to cup holders which overcomes or at least ameliorates some of the abovementioned disadvantages or which at least provides the public with a useful choice.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### BRIEF DESCRIPTION OF THE INVENTION

In a first aspect the present invention may broadly be said to be a cup holder comprising,

a housing,

a carrier member slidably engaged to the housing and movable between a condition where it is housed within the housing and condition where it at least partially extends from said housing,

a cup receptacle that is slidably connected to the carrier member and carried thereby in a gimballed manner,

wherein in an extended position the cup receptacle is presentable to be able to receive a cup,

and wherein in a retracted position the cup receptacle is within the housing in a stowed condition.

Preferably the cup holder is to be mounted at the seatback at the back of a seat.

Preferably the housing is mounted to the back of a seat, and projects into the seat back.

Preferably the housing and carrier member are configured such that the carrier member slides along an axis that is not perpendicular to the surface of the seat back.

Preferably the housing and carrier member are configured such that the carrier member slides along an axis that is perpendicular to the surface of the seat back.

Preferably the housing has a retaining arrangement for retaining the housing in the seat.

Preferably the retaining arrangement is a snap fit retaining arrangement.

Preferably the retaining arrangement is a positive lock retaining arrangement.

Preferably the carrier member is retained within the housing by a snap fit auxiliary retaining mechanism.

Preferably the carrier member is retained within the housing by a positive lock auxiliary retaining mechanism.

Preferably the cup holder is configured and mounted so that the cup holder is accessible to a person located to the rear of the seat.

Preferably the cup receptacle can receive and retain a cup, bottle, can or any similarly shaped article (herein after referred to as a “Cup”).

Preferably the cup receptacle comprises a girdle member and a pair of pivot lugs.

Preferably each pivot lug extends from opposing sides of the girdle member.

Preferably the pair of pivot lugs are on the same axis.

Preferably the carrier member comprises a pair of guide tracks each track configured to receive one of each of the pivot lugs.

Preferably the pair of guide tracks are configured to allow the pivot lugs to slide along the guide tracks.

Preferably the guide tracks and/or the pivot lugs are configured to allow the cup receptacle to pivot around the axis of the slide lugs.

In a second aspect the present invention may broadly be said to be a cup holder comprising,

a guide member,

a sliding member guided by and slidably engaged to the guide member,

the sliding member movable relative to the guide member between an extended position and a retracted position along a curved path,

a cup receptacle presentable by the sliding member, wherein in the extended position of the sliding member the cup receptacle is presented to be able to receive a cup,

and wherein in the retracted position of the sliding member the cup receptacle is more proximate the guide member.

Preferably the cup holder is to be mounted to the back of a seat.

Preferably the guide member is mounted to the back of the seat.

Preferably the guide member has a retaining arrangement for retaining the guide member in the seat.

Preferably the retaining arrangement is a snap fit retaining arrangement.

Preferably the retaining arrangement is a positive lock retaining arrangement.

Preferably the cup holder is configured and mounted so that the cup holder is accessible to a person located to the rear of the seat.

Preferably the cup receptacle can receive and retain a cup, bottle, can or any similarly shaped article (herein after referred to as a “Cup”).

Preferably the cup receptacle comprises a girdle member and a pair of lugs.

Preferably each lug extends from opposing sides of the girdle member.

Preferably the pair of lugs are on the same axis.

Preferably the guide tracks are configured to allow the pivot lugs to slide along the guide tracks.

Preferably the slide member is configured to support the cup receptacle by the lugs so as to allow the cup receptacle to pivot.

Preferably the guide tracks and/or the lugs are configured to allow the cup receptacle to pivot around the axis of the lugs.

In an alternative aspect the present invention may broadly be said to be a cup holder as herein described with reference to any one or more of the accompanying drawings.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE DRAWINGS

The present invention will now be described by way of example only and with reference to the following drawings in which:

FIG. 1 is a perspective view of one embodiment of the cup holder in the extended position,

FIG. 2 is a perspective view of the preferred embodiment of the cup holder in the retracted position,

FIG. 3 is a perspective view of the preferred embodiment of the cup receptacle in the extended position,

FIG. 4 is a perspective view of the preferred embodiment of the cup holder mounted to the back of a seat,

FIG. 5 is a perspective view of the preferred embodiment of the cup holder mounted to the back of a seat,

FIG. 6 is an enlarged perspective view of the preferred embodiment of the housing and the carrier member detailing the guide tracks and the retaining assembly,

FIG. 7 is a perspective view of the preferred embodiment of the cup receptacle in the extended position and including a cup,

FIG. 8 is an enlarged perspective view of the preferred embodiment of the housing and the cup receptacle in the retracted position,

FIG. 9 is a perspective view of an alternative embodiment of the cup holder mounted in a seat,

FIG. 10 is a perspective view of an alternative embodiment of the cup holder mounted in a seat and including a cup,

FIG. 11 is a side view of an alternative embodiment of the cup holder mounted in a seat and including a cup,

FIG. 12 is a perspective view of a preferred embodiment of the invention in an extended position with the housing shown in broken lines,

FIG. 13 is a top plan view of a preferred embodiment of the invention in an extended position with the housing shown in broken lines,

FIG. 14 is a side elevation view of a preferred embodiment of the invention in an extended position with the housing shown in broken lines,

FIG. 15 is a bottom plan view of a preferred embodiment of the invention in an extended position with the housing shown in broken lines,

FIG. 16 is a top plan view of a preferred embodiment of the invention in a partially retracted position with the housing shown in broken lines, and

FIG. 17 is a top plan view of a preferred embodiment of the invention in a fully retracted position with the housing shown in broken lines, and

FIG. 18 is a perspective view of a row of seats with one embodiment of a cup holder mounted on each seat.

### DETAILED DESCRIPTION OF THE INVENTION

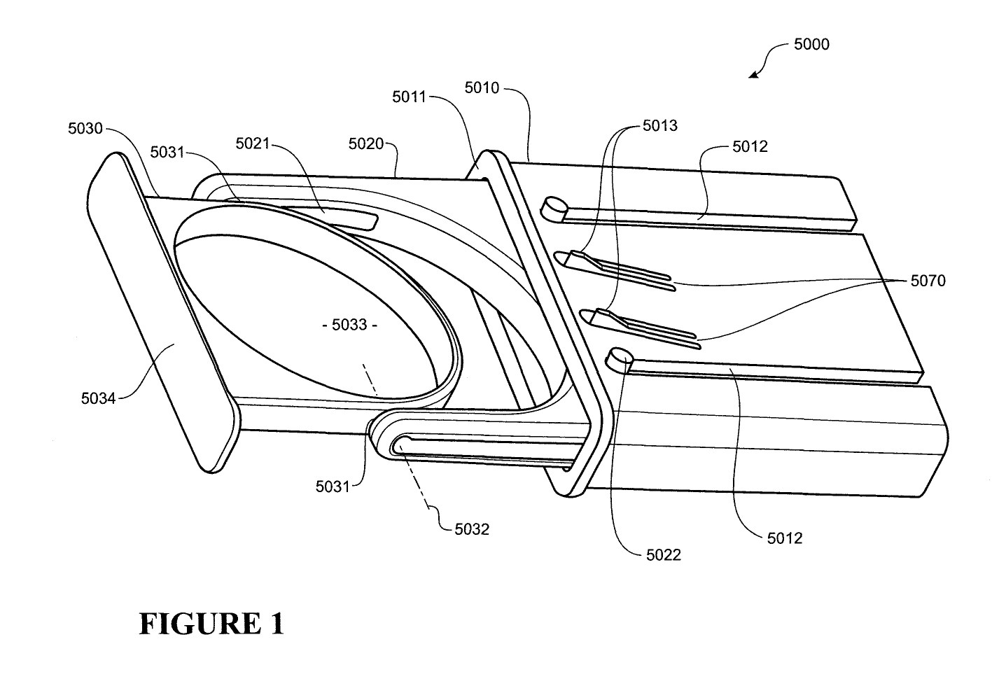

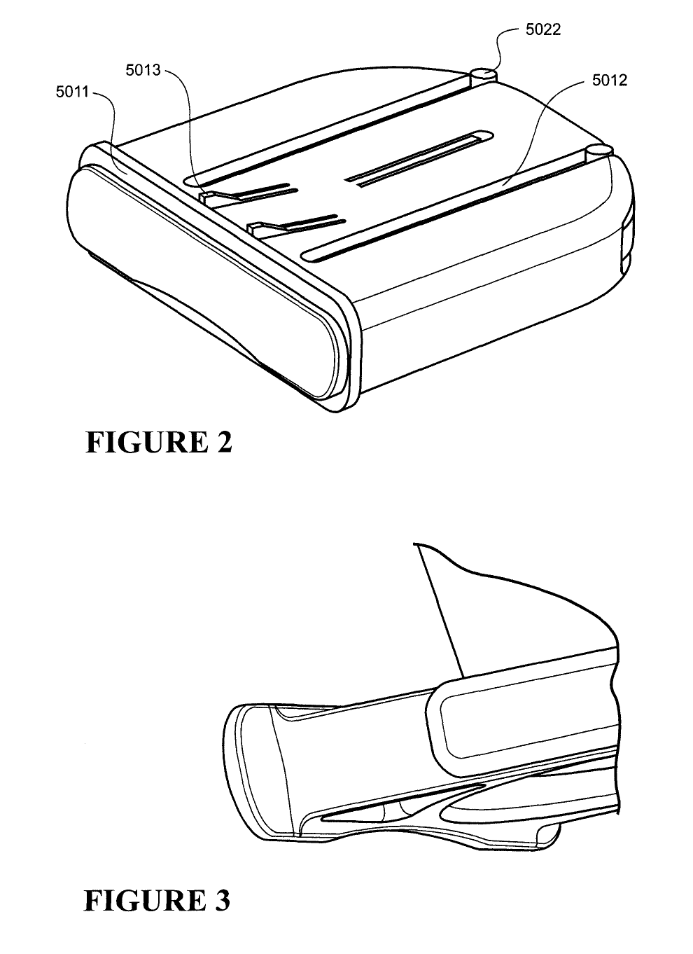

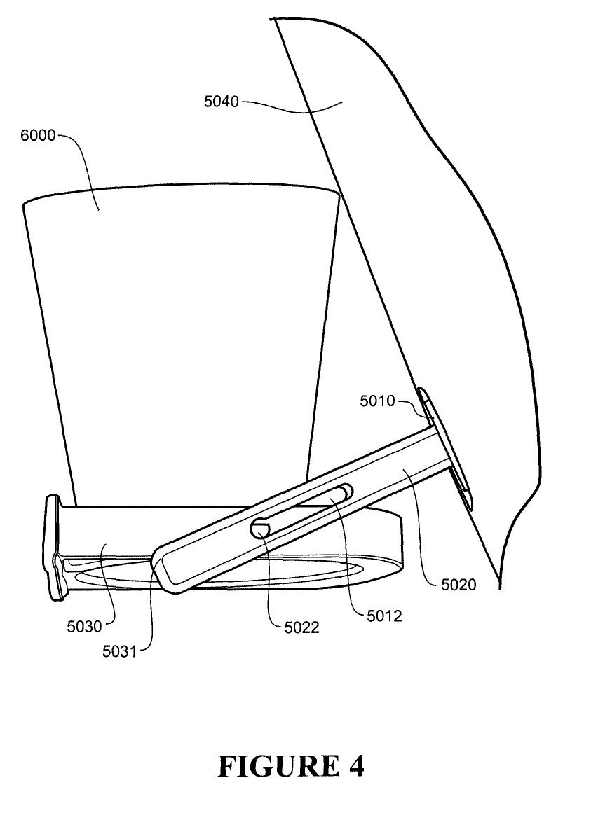

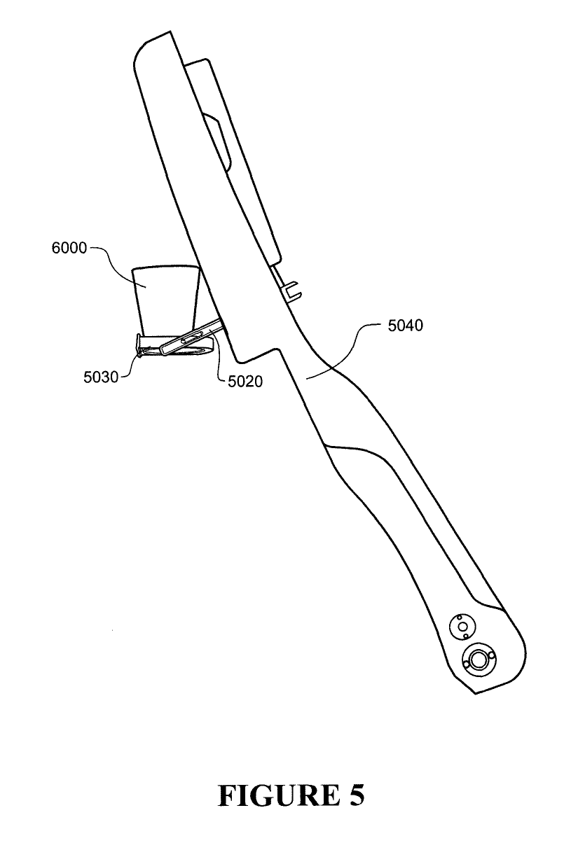

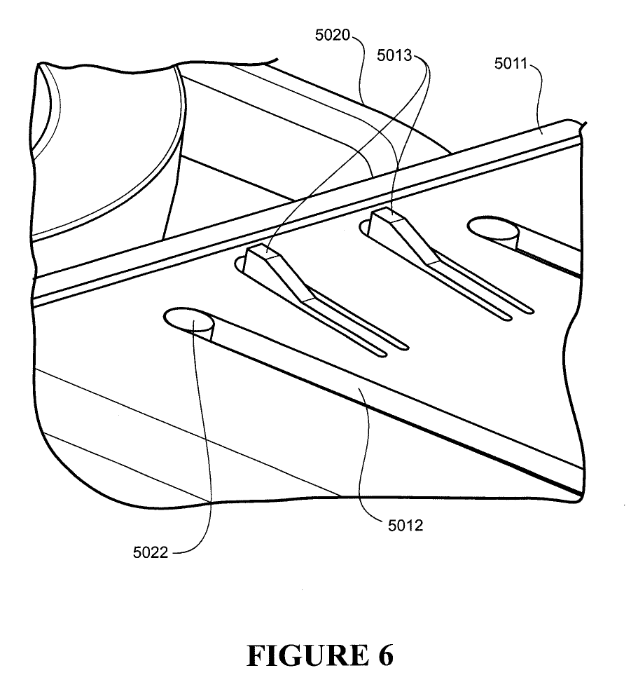

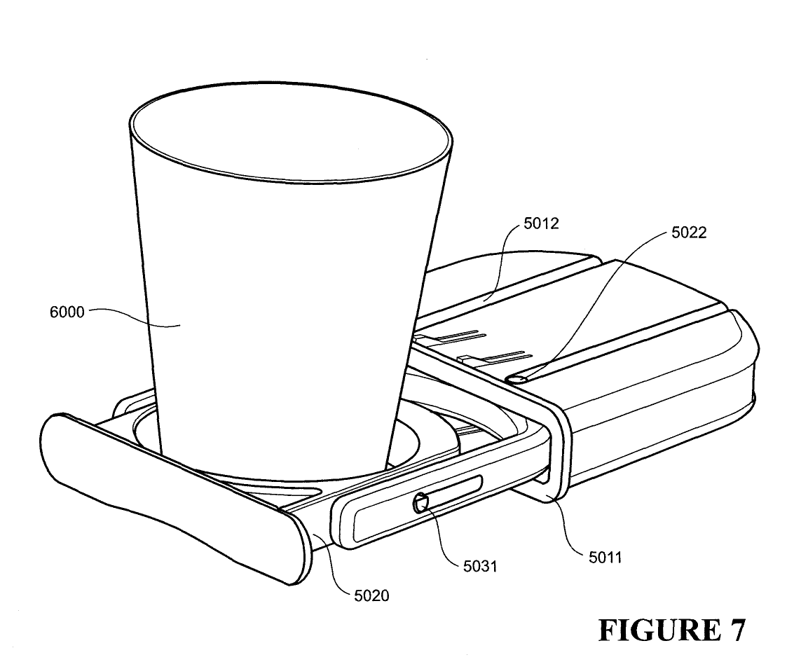

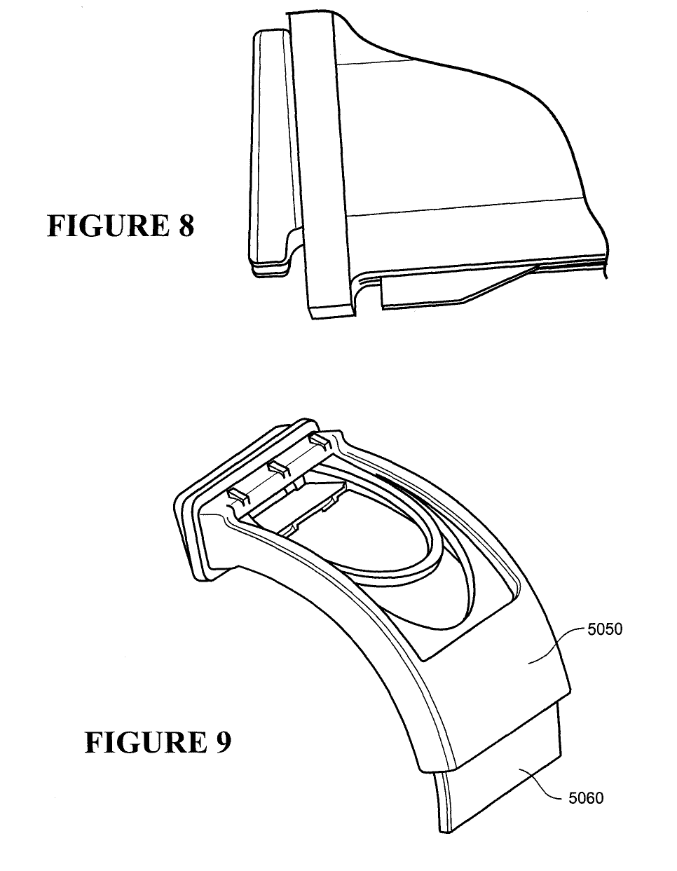

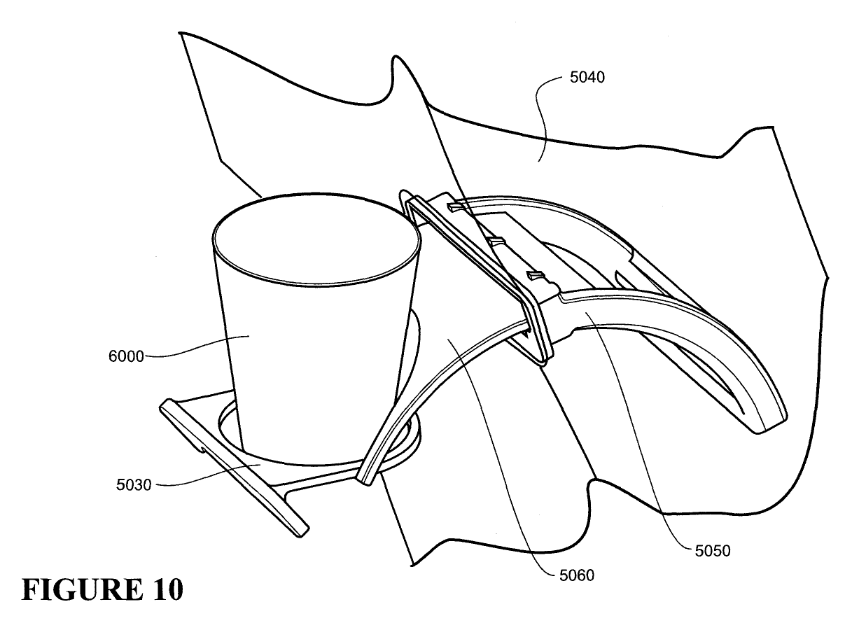

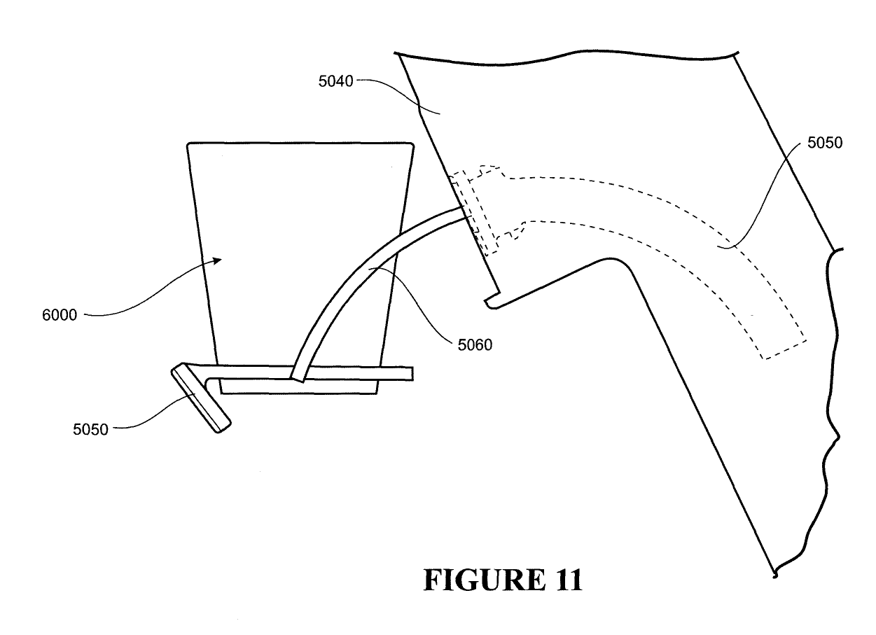

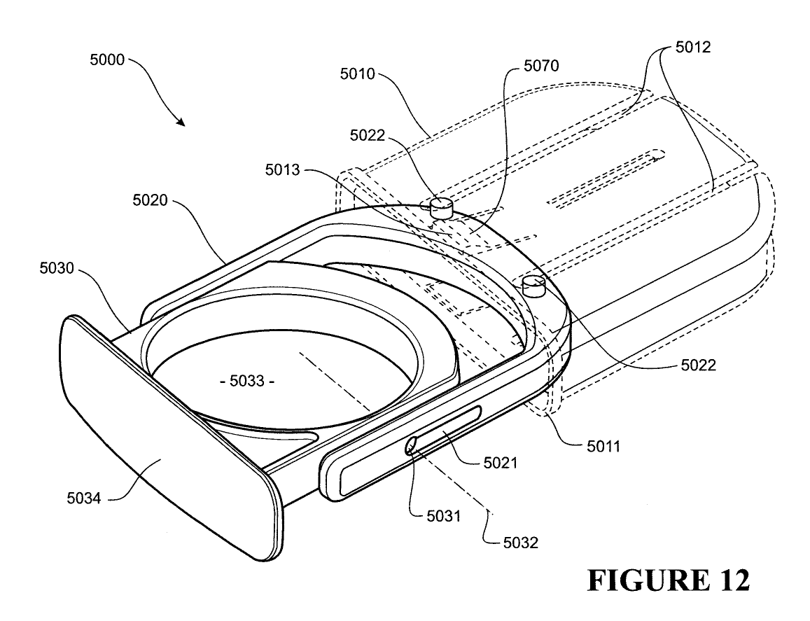

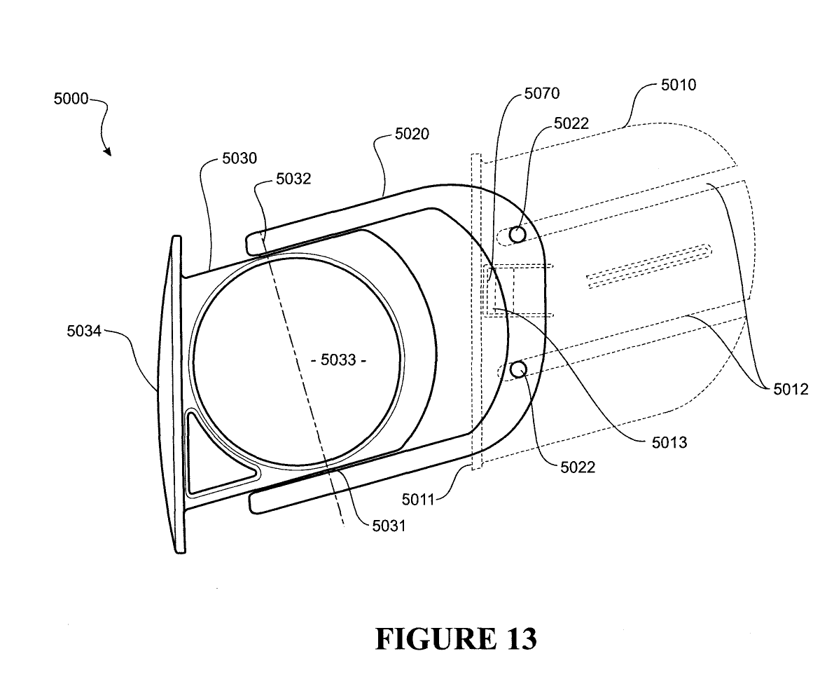

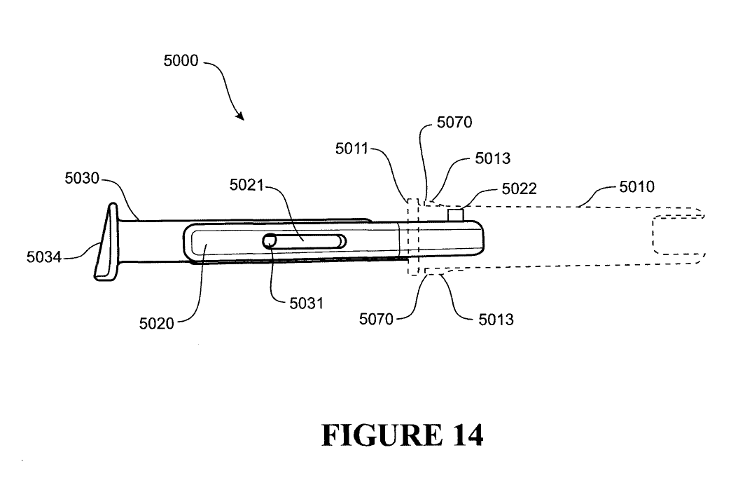

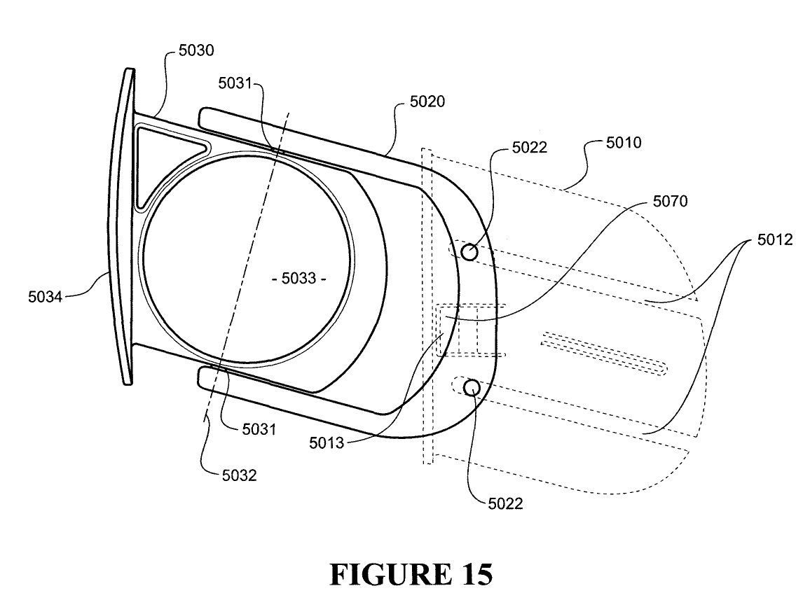

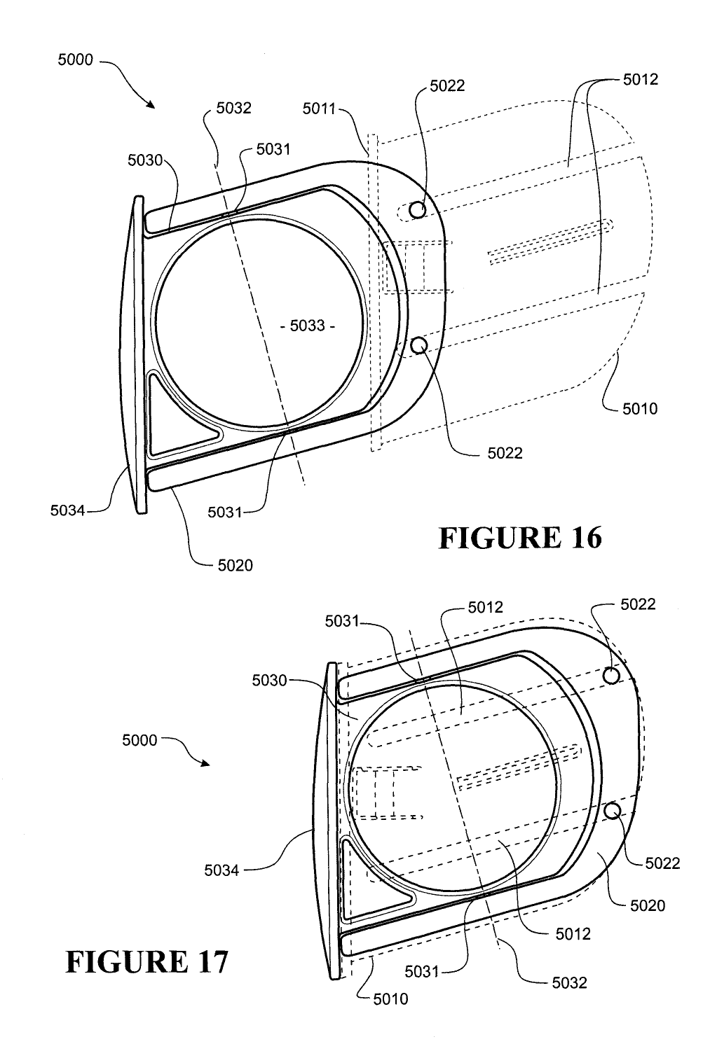

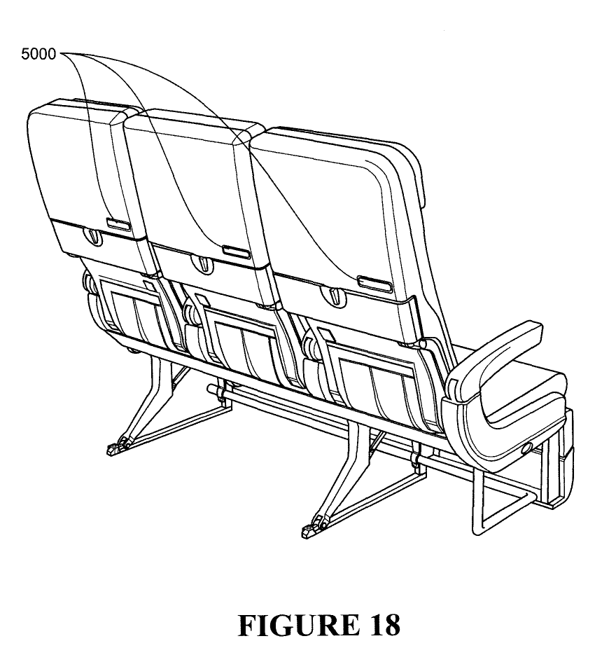

FIG. 1 shows a preferred embodiment of the cup holder 5000. In the preferred embodiment the cup holder comprises a housing 5010, a carrier member 5020 and a cup receptacle 5030. In the preferred embodiment the carrier member 5020 is slidably engaged to the housing 5010. The carrier member 5020 can be slid between a position where the carrier member is substantially enclosed within the housing and an extended position where it extends at least in part out of the housing. In the preferred embodiment the carrier member 5020 extends completely from the housing member 5010 to present the cup receptacle 5030.

The carrier member 5020 in the preferred embodiment forms a telescoping arrangement with the housing 5010 in which the housing 5010 forms the external sheath 5011 and the carrier member 5020 slides into and out of the external sheath 5011. Alternatively the carrier member 5020 could form the external sheath of the telescoping engagement.

In an alternative embodiment the carrier member 5020 is slidably engaged to the housing 5010 by any other sliding connection means such as a rail and coupling, a lug and groove or track system.

In the preferred embodiment the cup holder 5000 is mounted to the back of a seat 5040. In the preferred embodiment the cup holder 5000 is mounted to the back of the seat by inserting the housing member 5010 into the back of the seat. The housing member 5010 is inserted such that the carrier member slides in a substantially perpendicular direction to the surface of the seat back 5041. Alternatively the housing 5010 is at an angle to the seat back and the carrier member extends from the seat back 5041 at a non perpendicular angle.

In the preferred embodiment the housing 5010 comprises a retaining assembly 5070. The retaining assembly 5070 secures the housing in the back of the seat 5040. In the preferred embodiment the retaining assembly 5070 creates a snap fit between the housing 5010 and the seat 5040. In the preferred embodiment the snap fit is created by at least one retaining clips 5013 that engages with an equivalent bracket on the back of the seat thereby preventing the cup holder 5000 from falling out of the back of the seat 5040. In an alternative embodiment the retaining assembly creates a positive lock between the housing 5010 and the seat 5040.

In the preferred embodiment the cup holder 5000 is configured to be a cartridge type design such that the cup holder 5000 can be inserted into an aperture in the back of a seat 5040 designed for receiving the cup holder 5000. The cup holder 5000 in the preferred embodiment clips into place via the retaining assembly 5070 and can subsequently be used as a cup holder. In the preferred embodiment, in the event that the cup holder 5000 requires replacing the retaining assembly 5070 is readily releasable to allow the cup holder 5000 to be easily removed and replaced.

In the preferred embodiment the cup receptacle 5030 has a receiving aperture 5033 suitable for receiving a cup, can, bottle or any equivalent article of a similar shape and size. In a preferred embodiment the aperture is circular. Alternatively the aperture is a square, oval or any other shape suitable for receiving a cup.

In the preferred embodiment the cup receptacle 5030 has a pair of pivot lugs 5031 each lug located on opposite sides of the cup receptacle 5030 to one another. The pivot lugs 5031 are each engaged with a corresponding lug guide track 5021 in the carrier member 5020. The pivot lugs 5031 support the cup receptacle 5030 from the carrier member 5020 in a gimballed manner such that the cup receptacle 5030 can pivot and slide relative to the carrier member 5020. In the preferred embodiment the axis 5032 of the pivot lugs 5031 extends through the centre of gravity of the cup receptacle such that the cup receptacle is balanced and not biased in a particular direction, thus keeping the cup in an upright orientation. In the preferred embodiment the cup receptacle is pivoted such that when a cup or equivalent article is placed in the aperture the vessel is retained within the cup receptacle 5030.

In a preferred embodiment the aperture 5033 is configured to allow the narrow portion of the base of a cup to pass there through but is narrow enough to prevent the upper lip of the cup from passing. The prevention of the upper lip from passing supports the cup in the cup receptacle 5030. In a preferred embodiment the cup will pass substantially through the aperture 5033 such that the centre of gravity of the cup is substantially below the axis 5032 of the pivot lugs 5031. The centre of gravity of the cup being located below the axis of rotation causes the cup to always orientate itself in the vertical direction. If the vehicle moves then the cup and the cup receptacle will pivot to accommodate the change and ensure the cup stays up right and thus helps keep the contents of the cup, in the cup.

Alternatively the cup receptacle 5030 has a cup support that prevents a cup form passing completely through.

In the preferred embodiment the cup receptacle also comprises a facing member 5034. In the preferred embodiment the facing member 5034 is configured such that when the carrier member is in the retracted position the facing member is the only part of the cup receptacle 5030 and the carrier member 5020 that is visible from the back of the seat 5040. The facing member 5034 is configured such that a user can easily pull the cup receptacle 5030 and the carrier member 5020 out of the housing 5010. In a preferred embodiment the carrier member 5020 is retained within the housing 5010 when in the retracted position by a snap fit auxiliary retaining mechanism. Alternatively the carrier member 5020 is retained within the housing 5010 when in the retracted position by a positive lock auxiliary retaining mechanism. In the preferred embodiment the auxiliary retaining mechanism is a small protrusion that matches a small protrusion on the opposite component such that additional force is required to overcome their separation other than gravity.

In a preferred embodiment the carrier member is configured such that it is detachable from the housing 5010 but such that the carrier member 5020 will not fall out of the housing when it is moved into and extended position.

The housing 5010 in a preferred embodiment has at least one housing guide track 5012. The at least one housing guide track is configured to receive and guide an associated guiding lug 5022 located on the carrier member. The guide lugs 5022 and the housing guide track facilitate the sliding and guiding of the carrier member 5020 in and out of the housing 5010.

In an alternative embodiment the cup holder comprises a guide member 5050 mounted in the back of a seat 5040. The cup holder 5000 also includes a sliding member 5060 that slides into and out of the guide member 5050 along a curved path between a stowed and a deployed position. In the deployed position the slide member 5060 is configured to present the cup receptacle 5030 such that it can receive and support a cup 6000. In the stowed position the slide member is substantially concealed within the guide member and not extending from the back of the seat 5040. In this alternative embodiment the guide member 5050 is mounted to the back 5041 of a seat 5040 and the guide member and the sliding member 5060 are configured such that in the stowed position substantially all of the slide member is contained within the seat 5050. When the slide member 5060 moves between the stowed and the deployed position the slide member travels through a curved path. The seat is configured to accommodate the curved path of the slide member 5060 when in the stowed position. The cup receptacle 5030 is configured and mounted to the slide member 5060 in the same fashion that it is mounted to the carrier member 5020 of the preferred embodiment.

1. A cup holder comprising,
a housing,
a carrier member slidably engaged to the housing and movable between a condition where it is housed within the housing and condition where it at least partially extends from said housing,
a cup receptacle that is slidably connected to the carrier member and carried thereby in a gimballed manner,
wherein in an extended position the cup receptacle is presentable to be able to receive a cup,
and wherein in a retracted position the cup receptacle is within the housing in a stowed condition.

2. A cup holder as claimed in claim 1 wherein the cup holder is adapted to be mounted at the seatback at the back of a seat.

3. A cup holder as claimed in claim 1 wherein the housing is mounted to the back of a seat, and projects into the seat back.

4. A cup holder as claimed in claim 2 wherein the housing and carrier member are configured such that the carrier member slides along an axis that is not perpendicular to the surface of the seat back.

5. A cup holder as claimed in claim 3 wherein the housing and carrier member are configured such that the carrier member slides along an axis that is perpendicular to the surface of the seat back.

6. A cup holder as claimed in claim 2 wherein the housing has a retaining arrangement for retaining the housing in the seat.

7. A cup holder as claimed in claim 6 wherein the retaining arrangement is a snap fit retaining arrangement.

8. A cup holder as claimed in claim 6 wherein the retaining arrangement is a positive lock retaining arrangement.

9. A cup holder as claimed in claim 1 wherein the carrier member is retained within the housing by a snap fit auxiliary retaining mechanism.

10. A cup holder as claimed in claim 1 wherein the carrier member is retained within the housing by a positive lock auxiliary retaining mechanism.

11. A cup holder as claimed in claim 1 wherein the cup holder is configured and mounted so that the cup holder is accessible to a person located to the rear of the seat.

12. A cup holder as claimed in claim 1 wherein the cup receptacle can receive and retain a cup, bottle, can or any similarly shaped article.

13. A cup holder as claimed in claim 1 wherein the cup receptacle comprises a girdle member and a pair of pivot lugs.

14. A cup holder as claimed in claim 13 wherein each pivot lug extends from opposing sides of the girdle member.

15. A cup holder as claimed in claim 14 wherein the pair of pivot lugs are on the same axis.

16. A cup holder as claimed in claim 15 wherein the carrier member comprises a pair of guide tracks each track configured to receive one of each of the pivot lugs.

17. A cup holder as claimed in claim 16 wherein the pair of guide tracks are configured to allow the pivot lugs to slide along the guide tracks.

18. A cup holder as claimed in claim 17 wherein the guide tracks and/or the pivot lugs are configured to allow the cup receptacle to pivot around the axis of the slide lugs.

19. A cup holder comprising,
a guide member,
a sliding member guided by and slidably engaged to the guide member,
the sliding member movable relative to the guide member between an extended position and a retracted position along a curved path,
a cup receptacle presentable by the sliding member, wherein in the extended position of the sliding member the cup receptacle is presented to be able to receive a cup,
and wherein in the retracted position of the sliding member the cup receptacle is more proximate the guide member.

20. A cup holder as claimed in claim 19 wherein the cup holder is adapted to be mounted to the back of a seat.

21. A cup holder as claimed in claim 19 wherein the guide member is mounted to the back of a seat.

22. A cup holder as claimed in claim 19 wherein the guide member has a retaining arrangement for retaining the guide member in a seat.

23. A cup holder as claimed in claim 22 wherein the retaining arrangement is a snap fit retaining arrangement.

24. A cup holder as claimed in claim 22 wherein the retaining arrangement is a positive lock retaining arrangement.

25. A cup holder as claimed in claim 20 wherein the cup holder is configured and mounted so that the cup holder is accessible to a person located to the rear of the seat.

26. A cup holder as claimed in claim 19 wherein the cup receptacle can receive and retain a cup, bottle, can or any similarly shaped article.

27. A cup holder as claimed in claim 19 wherein the cup receptacle comprises a girdle member and a pair of lugs.

28. A cup holder as claimed in claim 27 wherein each lug extends from opposing sides of the girdle member.

29. A cup holder as claimed in claim 28 wherein the pair of lugs are on the same axis.

30. A cup holder as claimed in claim 29 wherein the guide tracks are configured to allow the pivot lugs to slide along the guide tracks.

31. A cup holder as claimed in claim 30 wherein the slide member is configured to support the cup receptacle by the lugs so as to allow the cup receptacle to pivot.

32. A cup holder as claimed in claim 30 wherein the guide tracks and/or the lugs are configured to allow the cup receptacle to pivot around the axis of the lugs.
